(19) United States
(12) Patent Application Publication
(10) Pub. No.: US 2025/0266214 A1
(43) Pub. Date: Aug. 21, 2025

(54) ELECTROCHEMICAL CELL COMPRISING A CAPACITOR AND ELECTROCHEMICAL SYSTEM

(71) Applicant: Reinz-Dichtungs-GmbH, Neu-Ulm (DE)

(72) Inventors: Verena STECK, Weissenhorn (DE); Marius PAETZOLD, Ulm (DE); Markus SCHIELE, Dietenheim (DE); Stephan WENZEL, Pfaffenhofen (DE)

(21) Appl. No.: 19/059,124

(22) Filed: Feb. 20, 2025

(30) Foreign Application Priority Data
Feb. 21, 2024 (DE) 20 2024 100 837.5

(51) Int. Cl. H01G 11/82; H01G 11/12

(52) U.S. Cl. CPC H01G 11/82; H01G 11/12

(57) ABSTRACT

The present disclosure relates to an electrochemical cell comprising a first separator plate, a second separator plate and a capacitor designed to store and release electrical energy. Furthermore, the present disclosure relates to an electrochemical system comprising a plurality of stacked electrochemical cells. The electrochemical system may be a fuel cell stack or an electrolyzer. The capacitor is arranged between an outer edge region of the first separator plate and an outer edge region of the second separator plate. The first separator plate has a first holding structure for holding the capacitor and/or the second separator plate has a second holding structure for holding the capacitor.

### CROSS REFERENCE TO RELATED APPLICATION

This application claims priority to German Utility Model Application No. 20 2024 100 837.5, entitled “ELECTROCHEMICAL CELL COMPRISING A CAPACITOR AND ELECTROCHEMICAL SYSTEM”, filed Feb. 21, 2024. The entire contents of the above-identified application is hereby incorporated by reference for all purposes.

### TECHNICAL FIELD

The present disclosure relates to an electrochemical cell comprising a first separator plate, a second separator plate and a capacitor designed to store and release electrical energy. Furthermore, the present disclosure relates to an electrochemical system comprising a plurality of stacked electrochemical cells. The electrochemical system may be a fuel cell stack or an electrolyzer.

### BACKGROUND AND SUMMARY

Fuel cells, particularly PEM fuel cells, which are stacked to form fuel cell stacks having a large number of individual cells, are used, for example, to generate electrical drive power in motor vehicles, such as passenger cars and commercial vehicles, as well as in ships and aircraft. However, the range of suitable operating conditions under which a fuel cell works optimally is quite small. On the other hand, the fuel cells should also be able to handle rapid load changes and power peaks, particularly in mobile applications.

Depending on the operating point, fuel cell stacks require very different volumes of reaction gases and coolants. It is beneficial to operate fuel cell stacks such that the supply of media is controllable. However, response times of the fans or pumps supplying the media cannot be avoided. Components that are significantly more agile than those currently in use are not available at a reasonable cost. An attempt is being made to avoid the harmful undersupply of H₂ or O₂ and to be able to safely dissipate the increased amount of heat by selecting fluid volumes according to the system's response time. In this process, a targeted excess of oxygen is often provided that is greater than the excess of hydrogen in relation to the respective operating point. On the other hand, in view of the component weight that must be transported in mobile applications and the associated costs, it does not make sense for the system or its components, especially pumps and/or fans for the media, to be designed to withstand the most extreme operating conditions. Therefore, it may be that when the system demands a significant increase in performance, in a region where immediately previously there was a sufficiently high concentration of hydrogen, the available or incoming hydrogen is no longer sufficient as a reaction partner for the incoming oxygen on the other side of the PEM. Carbon, which serves as a carrier for the fuel cell's electrochemical catalysts, could be an alternative reactant. The PEM or carbon carrier may become damaged in the process; in worst cases, the membrane itself may be perforated. The catalyst itself, usually mainly platinum, can also be damaged, for example, a reduction in the surface area available for the catalytic reaction may occur or the catalyst can become oxidated. It has been shown, however, that much larger amounts of media are often only needed for a limited time.

DE 10 2020 007 106 A1 proposes a fuel cell stack with a plurality of individual cells stacked and separated from one another by bipolar plates. In such a case, it is envisaged that the individual cells each have a photoelectric voltage generator assigned to them, wherein at least one light source is provided to generate voltage via the photoelectric voltage generators, whereby, using the generated voltage, an external current sacrificial anode can be implemented if required. Using an optocoupler, energy can be fed into each of the individual cells in the fuel cell stack in reverse. This is independent of the operation of the fuel cell stack. A light source can be used to generate the required voltage via the photoelectric voltage generators. This enables the formation of a sacrificial anode in each of the individual cells of the fuel cell stack by generating a voltage via the photoelectric voltage generators and a suitable light source during an air/air start, which counteracts the corrosion potential for the carbon-containing carriers of the catalysts. This enables corrosion to be avoided or at least reduced.

The disadvantage of this solution is that a large number of light sources must be provided in order to be able to supply all the photoelectric voltage generators in the fuel cell stack with light energy. These light sources have to be wired and maintained, which makes this solution less practical.

The present disclosure was conceived to solve, at least in part, the above-described problems.

An electrochemical cell is proposed according to a first aspect of the present specification. The electrochemical cell comprises a first separator plate, a second separator plate and a capacitor that is configured to store and release electrical energy. The capacitor is arranged between an outer edge region of the first separator plate and an outer edge region of the second separator plate. Furthermore, the first separator plate has a first holding structure to hold the capacitor and/or the second separator plate has a second holding structure to hold the capacitor.

The capacitor provides a short-term, quickly available power reserve that can supply electrical power during load changes when operating the electrochemical cell. This allows the electrochemical system, for example, to be smaller than conventional electrochemical systems, which are usually designed for the largest possible load and therefore oversized. Alternatively and/or additionally, particularly expensive agile components are not required. In addition, damage to the membrane electrode assembly (MEA) or the catalytic converter can be at least reduced, enabling the system to offer improved durability.

It is possible that the aforementioned holding structures are configured as embossed structures molded into the respective separator plate. The embossed structures can, for example, be molded into the separator plate together with other embossed structures—such as channel structures and/or sealing beads—in the same process step. This means that no additional process steps are required to form the holding structures.

At least one of the holding structures can define a receiving region for the capacitor, wherein the capacitor's active region and/or the receiving region are laterally delimited by at least one formation formed in the respective separator plate. In this context, delimited means that the capacitor cannot be moved further than the formation. Lateral tolerances may exist between the capacitor and the formation. The formation can be circumferential, so that there is only one circumferential formation; several formations can also be provided, however, at a distance from one another. The formation can be configured partly as a full bead and/or half bead. The formation can be molded into the separator plate together with other embossed structures. The active region of the capacitor is the region of the capacitor where charge or electrical energy is actually stored and/or released. The receiving region can be further delimited by a bottom surface of the respective separator plate. The bottom surface can extend along or parallel to a separator plate plane, but does not necessarily itself have to be configured as a flat surface, see also below.

In some embodiments, in order to clamp the capacitor, at least one of the holding structures has at least one spring structure that is configured to be resilient. Resilient may be understood as elastic, for example linearly elastic. At least one of the spring structures can have a wave-shaped portion, for example. The wave-shaped portion can extend within a formation, between formations and/or along the said bottom surface. Furthermore, the wave-shaped portion can have a lower maximum height than the formation(s). The height is measured perpendicular to the separator plate plane of the first and second separator plates. It is also possible that at least one of the holding structures is further configured to electrically contact the capacitor. Optionally, at least one of the spring structures can be configured as a clamping contact. In this case, the associated corresponding holding structure has a dual function (holding and electrical contact), which means that additional elements are not required. Alternatively, the electrical contact between the capacitor and the two separator plates can be established using suitable additional electrical contacts.

Provision may be made for the first holding structure to have first support structures and the second holding structure to have second support structures, wherein the first support structures and the second support structures typically face each other. In one embodiment, a part of the capacitor is held in position between the facing support structures. For example, a passive region of the capacitor, e.g. a protruding collar of the capacitor, a lateral projection of the capacitor or a conduit to the capacitor, is clamped or held between the support structures. Furthermore, the support structures are usually electrically insulated from each other. The electrical insulation can be effected, for example, by a protruding passive, particularly electrically insulated region of the capacitor, or by using a coating, which may be only partial, on the first separator plate and/or on the second separator plate.

The energy stored in the capacitor can be generated by electrochemical processes in the electrochemical cell. In this case, the electrochemical cell can operate independently of external current sources. In addition or alternatively, the capacitor can also be charged by a current source from outside the cell, for example before being put into operation, during downtimes or simply to absorb excess energy. As soon as the voltage in the electrochemical cell falls below the potential difference of the capacitor, the capacitor can compensate for the descending voltage by flowing electrons in the direction of the electrochemical cells. The capacitor releases the stored energy back to the electrochemical cell as electrical energy. As an advantage, the capacitor of an electrochemical cell is adapted to the delays in the system and the additional energy required as a result. The capacitor can, for example, be or comprise an electrochemical double-layer capacitor, for example a supercapacitor. The energy stored in the capacitor itself can be electrical energy in the form of an electrical potential or chemical/electrochemical energy. This is to be distinguished from batteries, accumulators and conventional capacitors, which are all based on other storage technologies. However, a person skilled in the art will be aware of the differences between the energy storage systems mentioned, which is why a detailed description is not provided here. Especially supercapacitors can react very quickly to load changes and thus reduce or minimize the dynamic stress on the electrochemical cell. Instead of a supercapacitor with a battery, a comparable electrochemical cell configured to absorb load changes using current battery technology would be significantly larger and heavier for the same capacity and dynamics. In addition, supercapacitors can draw power much faster than batteries.

Unlike in batteries, in double-layer capacitors no chemical reactions take place during charging and discharging. The main difference between conventional capacitors and supercapacitors is that the latter can store much more energy per unit volume. This is made possible by the porous surface structure (A) of the electrodes and the dissolved ions in the organic electrolyte, and the resulting very small distance (d) of the Helmholtz layer. The basis of the functional principle is the charge separation at two electrodes. In addition to the two electrodes, a supercapacitor cell usually has a separator and an electrolyte. The electrodes are usually made of activated carbon, which is applied at a thickness of between 100-200 μm to an aluminum support. In the literature, there are reports of electrode thicknesses in the nm and μm region. Many ions can be deposited because of the high surface area of the activated carbon. The activated carbon is often bound by a polymer, the aim being to hold the particles together and bind them to the substrate without impairing porosity. So far, graphite, conductive polymers and silicon dioxide have been tested as additives. The most commonly used electrolytes are acetonitrile as a solvent and tetraethylammonium borofluoride as dissolved salt. The separator serves as a separating material and should be mechanically stable, prevent a potential short circuit of the electrodes and enable good ion transport. Due to these requirements, polyolefin, paper or fabric, in each case soaked in the electrolyte, is often used.

While charging, the ions present in the electrolyte are attracted by the electrodes and aligned by their electric field. A double layer such as this is also called a Helmholtz layer. Positive and negative ions are present in the electrolyte, which are provided by the dissociation of the salt dissolved in the electrolyte and which are attracted to the negative and positive electrodes respectively. There is no change in the composition or phase transformation of the active materials. As a result, supercapacitors achieve cycle lifetimes that are two to three orders of magnitude longer compared to lithium-ion batteries. They may be designed as cylindrical cells, prismatic cells and pouch-bag cells.

Furthermore, the first separator plate and/or the second separator plate can have a sealing arrangement for sealing a fluid-guiding region of the respective separator plate. The respective separator plate can also have channel structures for guiding a fluid, for example in the fluid-guiding region. The outer edge region of the respective separator plate can be adjacent to the sealing arrangement. It should be noted here that at least one holding region defined by the holding structures, that is, said receiving region, is provided outside the sealing arrangement, i.e. between the outer edge and the sealing arrangement. In some embodiments, the sealing arrangement and the aforementioned formations can merge into one another.

The receiving region can be formed in an area of the separator plates that protrudes laterally from the electrochemical cell. For example, the separator plates each may comprise a projection in which the receiving region is formed. Alternatively, it is possible to form the receiving region within an otherwise essentially rectangular surface of the respective separator plate.

The outer edge region of the first separator plate and/or the outer edge region of the second separator plate, between which the capacitor is held, is optionally formed integrally with the first separator plate and/or integrally with the second separator plate, thus one-piece. This gives the system greater stability and avoids additional manufacturing steps. Alternatively, the outer edge region can also be connected to the respective separator plate, for example by using welded joints. This avoids excessive waste in the case of unfavorable overall geometries.

Often, the first separator plate is a cathode plate and the second separator plate is an anode plate, or vice versa. The electrochemical cell can also comprise units that are known per se, such as a membrane electrode assembly (MEA) with an electrochemically active membrane together with associated catalyst layers and a frame-shaped reinforcing layer and/or at least one gas diffusion layer, which extend flat between the two separator plates.

According to a further aspect of the present specification, an electrochemical system is proposed which comprises a plurality of stacked electrochemical cells of the type described above. Capacitors of adjacent cells can be arranged offset from each other in a direction perpendicular to the stacking direction, for example alternating, or arranged on top of each other in the stacking direction. The capacitors may thus have the same position in each alternating cell which position is different from the intermediate cell. For the purposes of this specification, adjacent can mean directly adjacent, i.e. without any intermediate cell, or indirectly adjacent, meaning that another cell can also be arranged between indirectly adjacent cells.

The energy stored in the capacitors of the electrochemical system can be generated in particular by electrochemical processes in the electrochemical system itself.

The electrochemical system can be a fuel cell stack or an electrolyzer.

The electrochemical cell can be a fuel cell. However, it can also be a cell of an electrolyzer, particularly a PEM electrolyzer. If two separator plates separate two cells from each other, for example in an electrolyzer, correspond to two layers of a bipolar plate, the above applies directly. However, if the separator plates that delimit two cells from each other in an electrolyzer are configured as a single layer forming a one-layered bipolar plate, the two separator plates that correspond to an electrochemical cell according to the present disclosure not only belong to this one cell, but each of these separator plates—or bipolar plates—belongs to the two cells that they delimit from each other. While stainless steel is the preferred material for the separator plates in fuel cells, titanium may be preferred for electrolyzers. In some applications, aluminum may be used as well.

Examples of embodiments of the electrochemical cell and the electrochemical system are shown in the attached figures and are explained in more detail in the following description.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows, in a perspective view, two bipolar plates each consisting of two separator plates, of the system according to the prior art, having a membrane electrode assembly (MEA) arranged between the bipolar plates.

FIG. 3A is a top view of a separator plate, which is a component of an electrochemical cell, according to one embodiment.

FIG. 3B is a cross-sectional view along section A-A of FIG. 3A through a part of an electrochemical cell.

FIG. 4A is a top view of a separator plate, which is a component of an electrochemical cell, according to a further embodiment.

FIG. 4B is a cross-sectional view along section B-B of FIG. 4A through a part of an electrochemical cell.

FIG. 5A is a top view of a separator plate, which is a component of an electrochemical cell, according to a further embodiment.

FIG. 5B is a cross-sectional view along section C-C of FIG. 5A through a part of an electrochemical cell.

FIG. 5C is a cross-sectional view along a section comparable to section D-D of FIG. 5A through a part of an alternative embodiment of an electrochemical cell.

FIG. 6 is a sectional view of an alternative embodiment of an electrochemical cell, in which only one of the two separator plates delimiting the cell has a holding structure for a capacitor.

FIG. 7 is a schematic illustration of an outer contour of a separator plate.

FIG. 8 is a schematic illustration of the outer contour of another separator plate.

### DETAILED DESCRIPTION

Here and in the following, recurring features in various figures are each labeled with the same or similar reference characters. In some cases, the repeated use of reference characters in the figures that follow has been omitted for the sake of clarity.

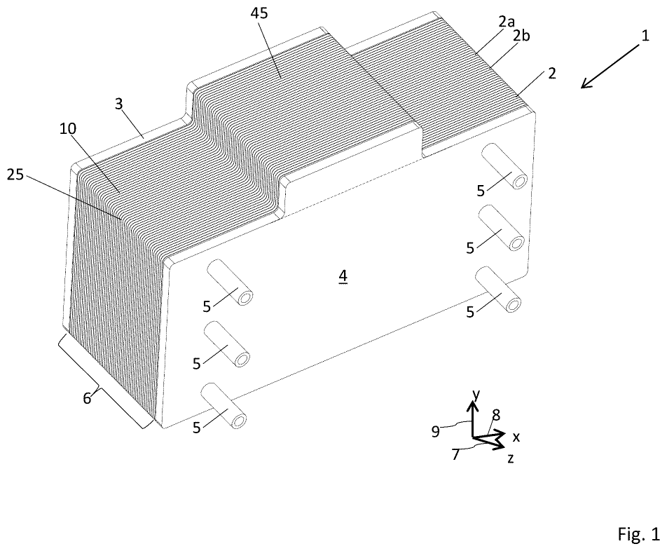

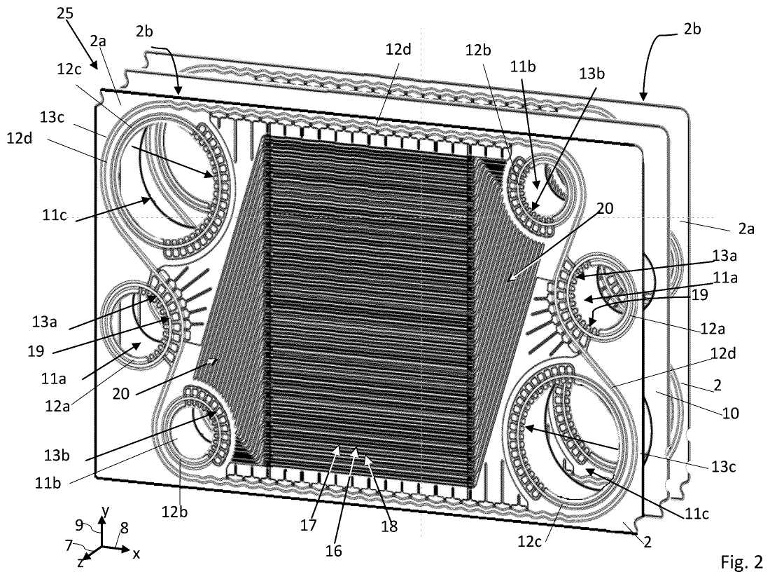

FIG. 1 shows an electrochemical system 1 with a plurality of identical metallic bipolar plates 2, which consist of separator plates 2a, 2b and, together with membrane electrode assemblies 10 and gas diffusion layers, form electrochemical cells 25, which are arranged in a stack 6 and are stacked along a z-direction 7. The bipolar plates 2 of the stack 6 are clamped between two end plates 3, 4. The z-direction 7 is also called the stacking direction. In this example, system 1 is a fuel cell stack. Two closest separator plates 2a, 2b of two adjacent bipolar plates 2 of the stack delimit an electrochemical cell 25, which is used, for example, to convert chemical energy into electrical energy. To form the electrochemical cells 25 of the system 1, a membrane electrode assembly (MEA) 10 is arranged between adjacent bipolar plates 2 of the stack, which is sometimes also called a membrane electrode assembly. The MEAs typically each contain at least one membrane, e.g. an electrolyte membrane. A gas diffusion layer (GDL) may also be arranged on one or both surfaces of the MEA (not illustrated in FIGS. 1 and 2).

In alternative embodiments, the system 1 can also be configured as an electrolyzer. Separator plates can also be used. The structure of these separator plates can then correspond to the structure of the separator plates 2a, 2b described in more detail here, even if the media fed onto or through the separator plates in an electrolyzer may differ from the media used for a fuel cell system. In an electrolyzer, a single separator plate 2a or 2b may form a bipolar plate 2.

Together with an x-axis 8 and a y-axis 9, the z-axis 7 spans a right-handed Cartesian coordinate system. The separator plates 2a, 2b define a plate plane at their contact plane, whereby the plate planes are each aligned parallel to the x-y plane and thus perpendicular to the stacking direction, that is, the z-axis 7. The end plate 4 comprises a plurality of media connections 5, via which media can be supplied to the system 1 and via which media can be discharged from the system 1. These media that can be supplied to and discharged from the system 1 can include, for example, fuels such as molecular hydrogen or methanol, reaction gases such as air or oxygen, reaction products such as water vapor or depleted fuels or coolants such as water and/or glycol. Gases are often supplied by means of fans and/or compressors, while coolant is usually supplied with the aid of at least one pump.

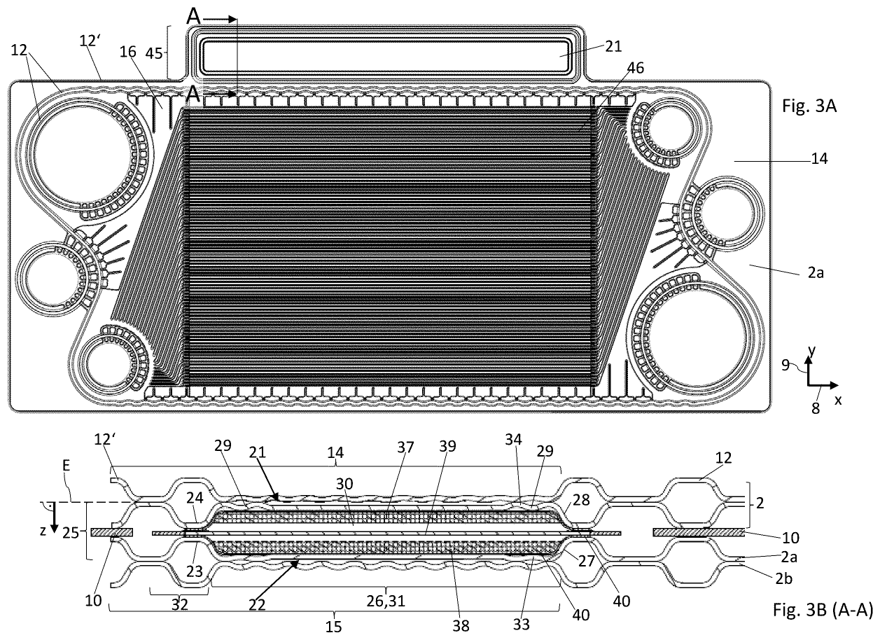

FIG. 2 shows a perspective view of two adjacent bipolar plates 2 of an electrochemical system of the type of system 1 of FIG. 1 as well as a membrane electrode assembly (MEA) 10 known from the prior art arranged between these adjacent bipolar plates 2, the MEA 10 in FIG. 2 being largely concealed by the separator plate 2 that faces the observer. The bipolar plate 2 is formed of two separator plates 2a, 2b, which are joined together by a material bond (see for example FIG. 3), of which only the first separator plate 2a that faces towards the observer is visible in FIG. 2, the said first separator plate obscuring the second separator plate 2b. The separator plates 2a, 2b may each be manufactured from a metal sheet, for example from a stainless steel sheet. The separator plates 2a, 2b may for example be welded to one another, for example by laser welded joints. Two closest separator plates 2a, 2b, together with the MEA 10 and any GDLs present, but not shown here, form an electrochemical cell 25.

The separator plates 2a, 2b have through-openings, which are aligned with each other and form through-openings 11a-c in the bipolar plate 2. When stacking a plurality of plates of the type of the bipolar plate 2, the through-openings 11a-c form conduits that extend through the stack 6 in the stacking direction 7 (see FIG. 1). Typically, each of the conduits formed by the through-openings 11a-c is fluidically connected to one of the media connections 5 in the end plate 4 of the system 1. It is possible for e.g. coolant to be introduced into the stack or discharged from the stack, via the conduits formed by the through-openings 11a. The conduits formed by the through-openings 11b, 11c, on the other hand, can be configured to supply fuel and reaction gas to the electrochemical cells 25 of the fuel cell stack 6 of the system 1 and to discharge the reaction products from the stack. The through-openings 11a-11c for the supply of media are formed essentially parallel to the plate plane, thus in the x-y-plane.

In order to seal off the through-openings 11a-c from the interior of the stack 6 and from the environment, the first separator plates 2a each have sealing arrangements in the form of sealing beads 12a-c that are each arranged around the through-openings 11a-c and each fully enclose the through-openings 11a-c. The second separator plates 2b, on the rear side of the bipolar plates 2 that faces away from the observer of FIG. 2, have corresponding sealing beads for sealing off the through-openings 11a-c (not shown).

In an electrochemically active region 18, the first separator plates 2a have, on their front side facing towards the observer of FIG. 2, a flow field 17 with structures for guiding a reaction medium along the front side of the separator plate 2a. These structures are provided in FIG. 2 by a plurality of webs and channels that run between the webs and that are delimited by the webs. On the front side of the bipolar plates 2 that faces the observer of FIG. 2, the first separator plates 2a also each have a distribution and collection region 20. Distribution or collection regions 20 each comprise structures that are designed to distribute a medium introduced into the distribution region 20 from a first of the two through-openings 11b over the active region 18, or to collect/bundle a medium flowing from the active region 18 to the second of the through-openings 11b. In FIG. 2, the fluid-guiding structures of both distribution or collection regions 20 are also webs and channels that run between the webs and delimited by the webs.

The sealing beads 12a-12c have feedthroughs 13a-13c that enable the passage of medium through the sealing beads 12a-12c.

The first separator plates 2a also each have a further sealing arrangement in the form of a perimeter bead 12d, which surrounds the flow field 17 of the active region 18, the distribution and collection regions 20 and the through-openings 11b, 11c and seals these off from the through-opening 11a, i.e. from the coolant circuit, and from the external environment of the system 1. The second separator plates 2b each comprise corresponding perimeter beads. The structures of the active region 18, the distribution structures of the distribution and collection region 20 and the sealing beads 12a-d are each formed integrally with the separator plates 2a and molded into the separator plates 2a, e.g. in an embossing or deep-drawing process or via hydroforming. The same applies to the corresponding structures of the second separator plates 2b.

The two through-openings 11b and the two conduits through the plate stack of the system 1 that are formed by the through-openings 11b, respectively, are each fluidically connected to one another via feedthroughs 13b in the sealing beads 12b, via the distributing structures of the distribution or collection region 20 and via the flow field 17 in the active region 18 of the first separator plates 2a facing towards the observer of FIG. 2. In an analogous manner, the two through-openings 11c and the two conduits formed by the through-openings 11c through the plate stack of the system 1, respectively, are in fluid connection with each other in each case via corresponding bead feedthroughs, via corresponding distribution and collection structures and via a corresponding flow field on an outer side of the second separator plates 2b facing away from the observer of FIG. 2. In contrast, the through-openings 11a and the two conduits through the plate stack of the system 1 that are formed by the through-openings 11a, respectively, are each fluidically connected to one another via a cavity 19 that is enclosed or surrounded by the separator plates 2a, 2b. This cavity 19 is used to guide a coolant through the bipolar plate 2, in particular to cool the electrochemically active region 18 of the separator plates 2a, 2b.

In the following, the sealing beads 12a, 12b, 12c, 12d are also collectively described as sealing arrangement 12. The sealing arrangement 12 thus comprises only one, at least one or all of the sealing beads 12a-d. Overall, the sealing arrangement 12 defines a fluid-guiding region 16 of the respective plate, within which the media (cooling fluid, reactants, product media) flow are guided.

The described separator plates 2a, 2b as well as the periphery of the fuel cell stack 1, e.g. fans and pumps, are usually designed for a specific load range of the electrochemical system 1. In order to also cover an upper load range, thus a higher load range than the specific load range, the periphery of the fuel cell stack as well as, for example, the through-openings 11a-c of the separator plates 2a, 2b, are usually oversized so that sufficient cooling is ensured for the increased amount of heat generated in the upper load range and undersupply with reactants can be avoided. For some applications, it would be desirable if the electrochemical system could be made more compact while simultaneously ensuring a safe operation.

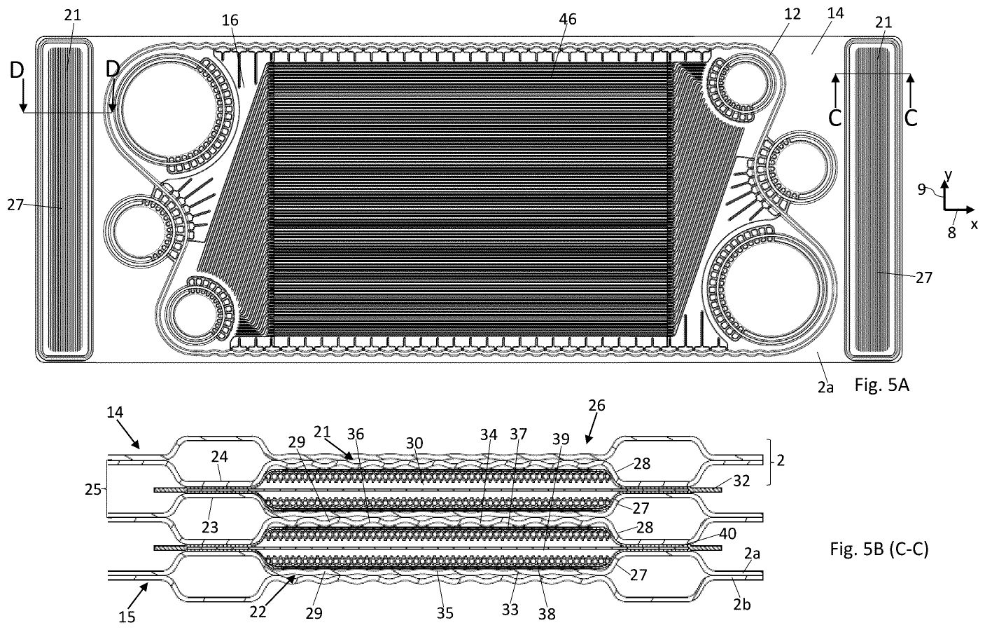

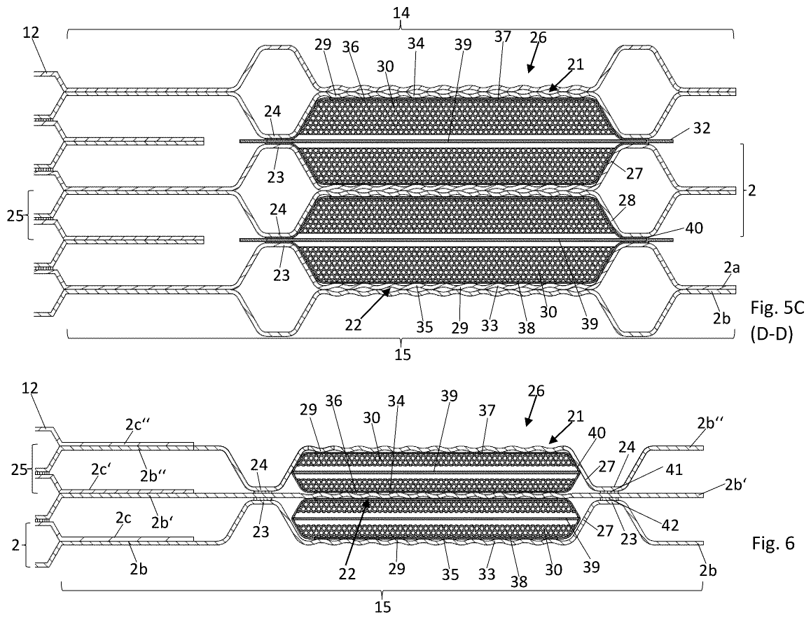

The present application was designed to solve this problem, at least in part. Various embodiments are shown in FIGS. 1 and 3A to 8 and are explained in more detail below. The separator plates 2a, 2b shown in FIGS. 3A to 8 can have individual, several or all of the features of the separator plates 2a, 2b of FIG. 2. A capacitor 30 is also provided, which is accommodated by the first separator plate 2a and/or the second separator plate 2b. The capacitors 30 are arranged between the outer edge regions of the respective separator plates 2a, 2b. The electrochemically active region of the respective cells 25 is thus distanced from the areas relevant for accommodating the capacitors 30, which are shown in the figures and described herein. The cells 25 are therefore usually only implied, and the structure of the cells 25 are not described in detail herein. With regard to FIGS. 5A, 5B, and 5C, the following should be noted: The top view in FIG. 5A can correspond to an example embodiment as shown in the cross-sectional view in FIG. 5B. Alternatively, the top view in FIG. 5A can also correspond to an example embodiment as shown in the cross-sectional view in FIG. 5C.

According to the embodiments of FIGS. 1 and 3A to 8, an electrochemical cell 25 is provided, which comprises a first separator plate 2a, a second separator plate 2b and a capacitor 30. The capacitor 30 is optionally a supercapacitor. If nothing further is explained below in the context of the term “capacitor”, this is also optionally a supercapacitor. The capacitor 30 is designed to store and release electrical energy. The capacitor 30 is arranged between an outer edge region 14 of the first separator plate 2a and an outer edge region 15 of the second separator plate 2b.

The separator plates 2a, 2b each have a sealing arrangement 12 for sealing a fluid-guiding region 16 of the respective separator plate 2a, 2b. In most cases, there is also a sealing arrangement 12′ in the form of a half bead along the outer edge of the separator plates 2a, 2b, which in some cases not only has a sealing function but also a supporting function. The respective separator plate 2a, 2b also comprises channel structures 46 to guide a fluid. The respective outer edge region 14, 15 is located outside the fluid-guiding region 16 of the respective separator plate 2a, 2b defined by the bead arrangement 12, and often adjoins the fluid-guiding region 16 of the plate 2a, 2b or the bead arrangement 12. In some embodiments, the separator plate 2a, 2b comprises the fluid-guiding region 16 and the outer edge region 14, 15, or consists only of these two regions. Alternatively, at least one further area of the separator plate 2a, 2b can be provided between the fluid-guiding region 16 and the outer edge region 14, 15.

The first separator plate 2a has a first holding structure 21 to hold the capacitor 30. Alternatively or additionally, the second separator plate 2b has a second holding structure 22 to hold the capacitor 30. The said holding structures 21, 22 can be designed as embossed structures molded into the respective separator plate 2a, 2b. The holding structures 21, 22 are therefore an integral component of the respective separator plate 2a, 2b. The term “embossing” used in this specification is intended to include forming methods such as stroke or roll embossing, deep drawing and/or hydroforming, so that this specification is not limited to one specific forming process for the embossed structures. Further embossed structures include, for example, the sealing arrangement 12 and the channel structures 46.

The holding structures 21, 22 define a receiving region 26 for the capacitor 30, in which the capacitor 30 is received and held. For the sake of simplicity, reference is made below to the holding structure 21, 22, whereby it may mean only one, at least one or both of the holding structures 21, 22. This applies analogously to other structures that are described in the singular.

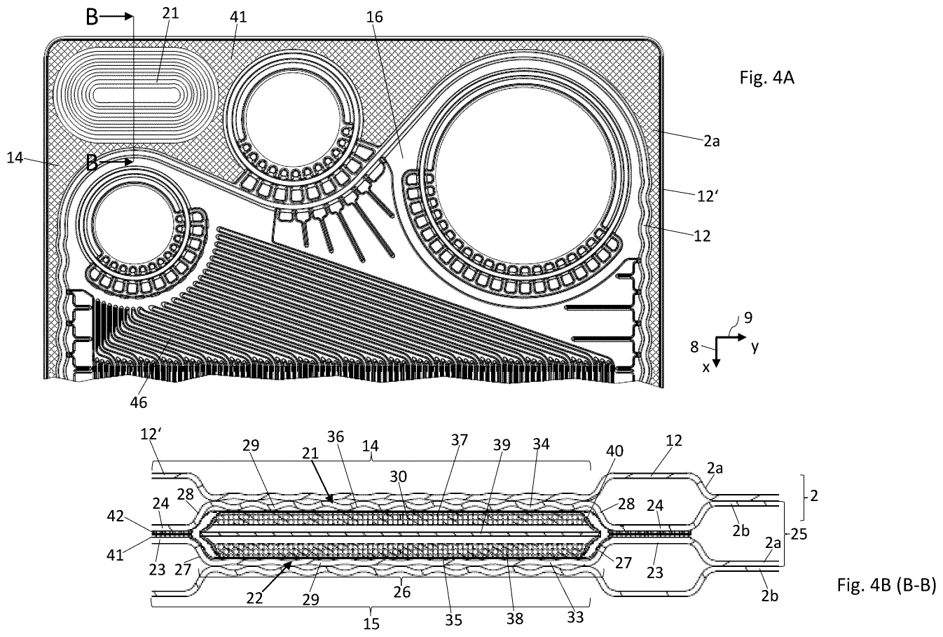

The holding structures 21, 22 can be formed in outer edge regions 14, 15 of separator plates 2a, 2b, see e.g. FIG. 4A. The resulting separator plates 2a, 2b can thus be integrated into existing electrochemical systems 1. Alternatively, the outer edge region 14, 15 may also have a projection 45, which protrudes laterally from the separator plate 2a, 2b, see e.g. FIG. 1 and FIG. 3A. The dashed line in FIG. 1 indicates the boundary of the projection 45; a corresponding projecting region is not present in a stack with separator plates as shown in FIG. 2. The receiving region 26 can be provided at least partially, or completely, in the region of the projection 45. In the embodiment of FIG. 5A/5B, the support structures 23, 24 of the holding structures 21, 22 extend in parallel and close to the edges of the separator plate 2a, 2b, in sections.

The capacitor 30 can have an active region 31 and a passive region 32. The active region 31 of the capacitor 30 typically forms the region of the capacitor 30 in which part of the electrical energy released by the electrochemical cell 25 is stored or can be released again by discharging the capacitor 30. No energy storage takes place in the passive region 32; the passive region 32 is only used for insulating and mounting the capacitor 30 between the support structures 23, 24.

The holding structure 21, 22 can have a bottom surface 35, 36 and side walls 27, 28. In the figures, the side walls are formations formed by beads 27, 28, for example by the lateral flanks of these beads. The formation 27, 28 can be configured partly as a full bead with two lateral flanks and/or a half bead with one lateral flank. The capacitor 30, for example the active region 31 of the capacitor 30, can be laterally delimited by at least one formation 27, 28 formed in the respective separator plate 2a, 2b. In a region between the bottom surface 35 and the bead arrangement 12, the formation 27, 28 can be configured as a full bead with two bead flanks. The example of FIG. 4A/B shows that the structure forming the formation 27, 28 can be identical to or part of the sealing structure 12. In a region between the bottom surface 35, 36 and the outer edge 43, 44 of the separator plate 2a, 2b, the formation 27, 28 can be designed as a half bead with only one bead flank, see FIG. 4B, or as a full bead with two bead flanks, see FIGS. 3B, 5B, and 6.

The holding structures 21, 22 can have support structures 23, 24 that face each other. In the region of the support structures 23, 24, the two support structures 23, 24 of the holding structures 21, 22 are supported by each other. The support structures 23, 24 are often electrically insulated from each other. For this purpose, the separator plates 2a, 2b can have an electrically-insulating coating 41, 42, which is arranged at least partly on the respective separator plate 2a, 2b, for example in the region of the support structures 23, 24, cf. FIGS. 4A, 4B, but often also beyond this, so that the entire outer edge region 14, 15 can be provided with the coating 41, 42, see FIG. 4A. Alternatively or additionally, the capacitor 30 can have an electrically insulating sheath 40, see FIGS. 3B, 5B, 5C.

In some embodiments, a part of the capacitor 30, for example the passive region 32 of the capacitor such as a protruding collar or a lateral extension of the capacitor 30, may be held between the facing support structures 23, 24, see. FIGS. 3B, 5B. It is advantageous if the support structures 23, 24 are resiliently supported by each other. The support structures 23, 24 can be configured as bead roofs of the full beads or half beads of the formation 27, 28. In some embodiments, the sealing arrangement 12 and individual elements of the aforementioned holding structures 21, 22, such as the support structures 23, 24, can merge into one another. For example, the sealing arrangement 12 designed as a full bead and the sealing arrangement 12′ designed as a half bead, which is not arranged in fluid-guiding region 16 but in the outer edge region 14 or 15, form the formations 27, 28 in FIG. 4B at the same time. It should be noted that at least the receiving region 26 is normally provided outside of the fluid-guiding region 16 and the sealing arrangement 12, see FIGS. 3A-6.

The cross-sectional view in FIG. 3B also shows part of the MEA 10. This visible part is a reinforcing edge that reinforces the membrane of the MEA 10 and is typically made of an electrically insulating material.

Furthermore, the holding structure 21, 22 has a spring structure 33, 34, which is designed to be resilient in order to clamp the capacitor 30. For this purpose, the spring structure 33, 34 can have a wave-shaped portion 29 or an overall wave-shaped design. The wave-shaped portion 29 usually extends partially (cf. FIG. 3B) or completely (cf. FIGS. 4B, 5B) along the bottom surface 35, 36 of the holding structure 21, 22, for example within a region delimited by the formation 27, 28. Furthermore, the wave-shaped portion 29 has a lower maximum height than the respective formation 27, 28, the height being measured in the z-direction perpendicular to the plate plane E of the first separator plate 2a and the second separator plate 2b. The maximum height therefore here describes the maximum extension of the respective element perpendicular to the plate plane E. The plate plane E and the z-direction perpendicular to it are indicated for clarity in FIG. 3B. The separator plate plane E of the respective separator plate 2a, 2b is determined in regions in which the separator plate is flat and does not include any embossed structures.

The holding structure 21, 22 can also be configured to make electrical contact with the capacitor 30. The electrical contacting of the capacitor 30 can for example be effected by the resilient part of the holding structure 21, 22, i.e. by the spring structures 33, 34, whereby the spring force of the spring structures 33, 34 ensures that the capacitor 30 is always in electrical contact with the respective separator plate 2a, 2b. The spring structure 33, 34 is thus optionally designed as a clamping contact. This eliminates the need for additional electrical wiring between the capacitor 30 and the separator plate 2a, 2b.

In total, at least one or each holding structure 21, 22 can have at least one of the following elements: Formation 27, 28, bottom surface 35, 36, support structure 23, 24, insulating coating 41, 42 and/or spring structure 33, 34.

The capacitor 30 can be or comprise an electrochemical double-layer capacitor, for example a supercapacitor. Energy can be advantageously generated by electrochemical processes in the electrochemical cell 25 and then stored in the capacitor 30. For example, the energy stored in the capacitor 30 is generated at least by electrochemical processes in the electrochemical system 1. Alternatively, an additional or external current source can be provided to charge the capacitor 30.

Conventional supercapacitors can be used for the capacitor 30. For example, the capacitor 30 usually has a separator 39 and two opposing electrodes 37, 38, with the separator 39 separating the two electrodes 37, 38 from each other. For further features and properties of the capacitor 30, please refer to Andrew F. Burke, Jingyuan Zhao, Past, present and future of electrochemical capacitors: Technologies, performance and application, Journal of Energy Storage, 35 (2021) 102310, referenced.

The embodiment of FIG. 6 differs from the embodiments of FIGS. 3A-5C in that only one of the two separator plates 2c, 2b or 2c′, 2b′ or 2c″, 2b″ of a bipolar plate 2, namely the separator plate 2b or 2b′ or 2b″, forms a receiving region 26 with formations 27 for the capacitor 30. Unlike the separator plates 2a of the previous embodiments, the separator plates 2c, 2c′ and 2c″ do not extend into the region in which the capacitor or capacitors 30 are accommodated. The terms used for the separator plates 2b, 2b′, 2b″, 2c, 2c′, 2c″ differs here accordingly from the terms used for the separator plates in the preceding embodiments. The holding structure 22 of the separator plate 2b′ only has a bottom surface 36 with a spring structure 34, and does not have a formation 27, 28. Optionally and/or alternatively, the separator plate 2b′ can also be configured as a completely flat surface in the region of the capacitor 30. The separator plates 2b, 2b′ are similar in the receiving regions 26 to the corresponding sections of the separator plates 2a, 2b of the preceding embodiments and are essentially mirror-symmetrical to one another. The embodiment of FIG. 6 differs from the other embodiments in that here the separator plate 2b′ forms the first separator plate, and the first holding structure and the separator plate 2b form the second separator plate, which has the second holding structure for holding the capacitor 30. Both of the two separator plates 2b, 2b′ are therefore either anode plates or cathode plates.

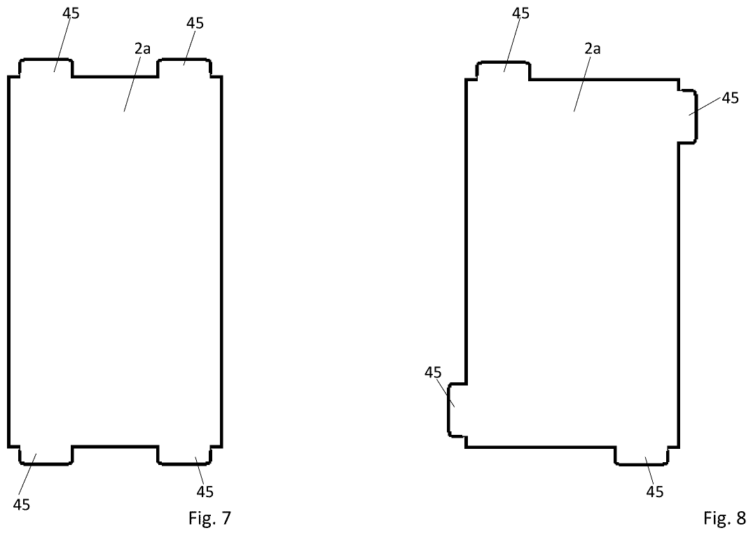

FIGS. 7 and 8 only show the outer contours of a separator plate 2a. A few possible positions for the projections 45 can be seen, whereby the projections 45 in FIGS. 7-8 are optionally arranged in such a way that the outer contours 7, 8 are rotationally symmetrical. The projections 45 of a separator plate 2a do not all have to accommodate a capacitor 30. Rather, for reasons of space in the electrochemical system 1, alternate ones of the projections 45 can accommodate a capacitor 30.

It should be noted that the separator plate 2a, 2b shown in FIGS. 5A-5C is also rotationally symmetrical.

The first separator plate 2a can be configured as a cathode plate, while the second separator plate 2b is an anode plate, or vice versa. When assembling the electrochemical cells 25, finished capacitors 30 or capacitor packs are optionally used, which are then arranged between the separator plates 2a, 2b.

The outer edge region 14 of the first separator plate 2a and/or the outer edge region 15 of the second separator plate 2b, between which the capacitor is held, is integrally formed with the first separator plate 2a or integrally with the second separator plate 2b in all the embodiments shown. This gives the system 1 greater stability and avoids additional manufacturing steps.

According to one aspect, an electrochemical system 1 comprising a plurality of stacked electrochemical cells 25 of the type described above is proposed here. Here, capacitors 30 of adjacent cells 25 are arranged offset from one another in a direction perpendicular to the stacking direction, optionally alternating, or are arranged on top of one another in the stacking direction.

FIG. 5C shows an embodiment in which capacitors 30 are arranged in the electrochemical system between every second pair of separator plates 2a, 2b that belong to two different bipolar plates 2 and that are closest to each other. The outer region of the other pairs of plates does not extend into the receiving region illustrated in 21, 22, but is recessed in this region. Optionally, corresponding receiving regions 21, 22 are provided in the other pairs of plates at a second outer edge, for example the outer edge at which cross-section C-C is indicated in FIG. 5A. This makes it possible to accommodate capacitors 30 with a greater overall height than is possible in FIGS. 3B and 4B, for example. Due to the rotational symmetry of the separator plates 2a, 2b, it is still possible to use identical parts.

For all of the aforementioned embodiments, as soon as the voltage in the stack 1 decreases, the capacitors 30 can temporarily compensate for this and thus counteract any damage to the system.

1. An electrochemical cell, comprising a first separator plate, a second separator plate and a capacitor that is configured to store and supply electrical energy, wherein the capacitor is arranged between an outer edge region of the first separator plate and an outer edge region of the second separator plate, wherein the first separator plate has a first holding structure for holding the capacitor and/or the second separator plate has a second holding structure for holding the capacitor.

2. The electrochemical cell according to claim 1, wherein at least one of said first holding structure and said second holding structure are configured as embossed structures molded into the respective separator plate.

3. The electrochemical cell according to claim 1, wherein at least one of the first holding structure and the second holding structure defines a receiving region for the capacitor, wherein an active region of the capacitor is delimited laterally by at least one formation formed in the respective separator plate.

4. The electrochemical cell according to claim 1, wherein the first holding structure comprises first support structures and the second holding structure comprises second support structures, wherein the first support structures and the second support structures face each other and are electrically insulated from each other.

5. The electrochemical cell according to claim 1, wherein at least one of the first holding structure and the second holding structure comprises at least one spring structure that is configured to be resilient, wherein the at least one spring structure is configured to clamp the capacitor.

6. The electrochemical cell according to claim 5, wherein the at least one spring structure comprises at least one wave-shaped portion.

7. The electrochemical cell according to claim 6, wherein the at least one wave-shaped portion extends within at least one formation formed in the first separator plate or the second separator plate which laterally delimits an active region of the capacitor or between at least two formations and has a smaller maximum height than the respective formation wherein the height is measured perpendicular to a plate plane of the first separator plate and the second separator plate.

8. The electrochemical cell according to claim 1, wherein at least one of the first holding structure and the second holding structure is further configured to electrically contact the capacitor.

9. The electrochemical cell according to claim 1, wherein the capacitor is or comprises an electrochemical double-layer capacitor.

10. The electrochemical cell according to claim 1, wherein the first separator plate and/or the second separator plate comprise a sealing arrangement for sealing a fluid-guiding region of the respective separator plate, wherein the outer edge region of the respective separator plate adjoins the sealing arrangement.

11. The electrochemical cell according to claim 1, wherein the first separator plate is a cathode plate and the second separator plate is an anode plate.

12. The electrochemical cell according to claim 1, wherein at least one of said outer edge region of the first separator plate and said outer edge region of the second separator plate, between which the capacitor is held, is formed integrally with the first separator plate and/or is formed integrally with the second separator plate.

13. An electrochemical system, comprising a plurality of stacked electrochemical cells according to claim 1, in which capacitors of adjacent cells are offset from each other in a direction perpendicular to a stacking direction of the plurality of stacked electrochemical cells or are arranged on top of one another in the stacking direction.

14. The electrochemical system according to claim 13, wherein energy stored in the capacitors is generated by electrochemical processes in the electrochemical system.

15. The electrochemical cell according to claim 9, wherein the electrochemical double-layer capacitor is a supercapacitor.

16. The electrochemical system according to claim 13, wherein the capacitors of adjacent cells are alternately offset from each other in a direction perpendicular to the stacking direction.
